(19) United States
(12) Patent Application Publication
(10) Pub. No.: US 2024/0092689 A1
(43) Pub. Date: Mar. 21, 2024

(54) COOKING PLATE, MANUFACTURING METHOD THEREOF, AND COOKING APPARATUS INCLUDING COOKING PLATE

(71) Applicant: SAMSUNG ELECTRONICS CO., LTD., Suwon-si (KR)

(72) Inventors: Jiyoung SONG, Suwon-si (KR); Hyunseok SHIN, Suwon-si (KR); Youngdeog KOH, Suwon-si (KR); Kwangjoo KIM, Suwon-si (KR)

(73) Assignee: SAMSUNG ELECTRONICS CO., LTD., Suwon-si (KR)

(21) Appl. No.: 17/520,192

(22) Filed: Nov. 5, 2021

(51) Int. Cl. C03C 17/42; F24C 15/10; H05B 3/74

(52) U.S. Cl. CPC C03C 17/42; F24C 15/10; H05B 3/74; C03C 2217/28; C03C 2218/151

(57) ABSTRACT

A cooking apparatus includes a main body, and a cooking plate mounted on an upper surface of the main body to cook a cooking material. The cooking plate includes a base material, a diamond-like carbon (DLC) coating layer formed on an upper surface of the base material, to contact a cooking container when the cooking container is placed on the cooking plate, and an adhesive layer interposed between the base material and the DLC coating layer, and including at least one of Si and SiOx.

### BACKGROUND

### 1. Field

The disclosure relates to a cooking plate, a manufacturing method thereof, and a cooking apparatus including the cooking plate. For example, the disclosure relates to a cooking plate with improved durability by changing a surface treatment method, a manufacturing method thereof, and a cooking apparatus including the cooking plate.

### 2. Description of the Related Art

A cooking apparatus includes equipment for heating a cooking material such as food to cook the cooking material, and the cooking apparatus includes an induction range, a highlight range, a gas range, an electric range, etc.

A cooking plate forming the top of the cooking apparatus may need characteristics or features which enable easy cleaning of food such as kimchi, heat tolerance performance capabilities to withstand high temperatures, chemical resistance, scratch resistance, etc.

### SUMMARY

A cooking apparatus according to examples of the disclosure includes a main body, and a cooking plate mounted on an upper surface of the main body to cook a cooking material. The cooking plate includes a base material, a diamond-like carbon (DLC) coating layer, formed on an upper surface of the base material as an outermost layer of the cooking plate and on which a cooking container is placeable, and; including at least one of Si and SiOx.

The adhesive layer may include trimethoxysilane (TMS) to improve an adhesive force between the base material and the DLC coating layer.

The base material may include ceramic glass.

At least one of the DLC coating layer and the adhesive layer may be formed by a physical vapor deposition (PVD) method.

The PVD method may include a linear ion source (LIS) method of spraying an ion beam.

A thickness of the adhesive layer may be 0.1 μm to 0.9 μm.

A thickness of the DLC coating layer may be 1 μm to 3 μm.

A method of manufacturing a cooking plate, according to examples of the disclosure, includes preparing a base material including ceramic glass, coating a buffer layer including at least one of Si and SiOx on the base material, and coating a diamond-like carbon (DLC) coating layer on the buffer layer. The buffer layer is interposed between the DLC coating layer and the ceramic glass.

The buffer layer may include trimethoxysilane (TMS) to improve an adhesive force between the base material and the DLC coating layer.

The method may further comprise etching a surface of the base material through linear ion source (LIS) processing before coating the DLC coating layer.

The method may further comprise performing a physical vapor deposition (PVD) method to coat at least one of the DLC coating layer and the buffer layer.

The physical vapor deposition (PVD) method may include a linear ion source (LIS) method, and a supply voltage of the LIS method may be 500 V to 2900 V.

A supply power of the LIS method may be 300 W to 2900 W.

A thickness of the buffer layer may be 0.1 μm to 1.0 μm, and a thickness of the DLC coating layer may be 0.5 μm to 2.0 μm.

The DLC coating layer may be an outermost surface of the cooking plate on which a cooking container is to be placed.

A cooking plate according to examples of the disclosure includes a base material including ceramic glass, a diamond-like carbon (DLC) coating layer formed on an upper surface of the base material, and an adhesive layer interposed between the base material and the DLC coating layer. The adhesive layer may include at least one of Si and SiOx.

The adhesive layer may include trimethoxysilane (TMS) to improve an adhesive force between the base material and the DLC coating layer.

At least one of the DLC coating layer and the adhesive layer may be formed by a physical vapor deposition (PVD) method.

The physical vapor deposition (PVD) method may include a linear ion source (LIS) method.

A thickness of the adhesive layer may be 0.1 μm to 1.0 μm, and a thickness of the DLC coating layer may be 0.5 μm to 2.0 μm.

### BRIEF DESCRIPTION OF THE DRAWINGS

The above and other aspects, features and advantages of the disclosure will become more apparent from the following description of example embodiments with reference to the accompanying drawings, in which:

FIG. 1 is a perspective view of a cooking apparatus according to an embodiment of the disclosure.

FIG. 2 shows laminating of a cooking plate in the cooking apparatus shown in FIG. 1.

FIG. 3 is a flowchart showing a method of manufacturing the cooking plate shown in FIG. 2.

FIG. 4 is a flowchart showing the method of manufacturing the cooking plate, shown in FIG. 3.

FIG. 5 schematically shows a process for forming the cooking plate shown in FIG. 2.

FIG. 6 shows laminating of a cooking plate in a cooking apparatus according to an embodiment of the disclosure.

FIG. 7 is a table showing changes of surface hardness and a friction coefficient of a cooking plate according to an embodiment of the disclosure.

FIG. 8 is a graph showing changes of a friction coefficient of a cooking plate according to an embodiment of the disclosure.

FIG. 9 includes pictures (a) and (b) showing the surface states of a cooking plate subject to a coating process according to an embodiment of the disclosure before and after a hot water resistance test is applied to the cooking plate.

FIG. 10 includes pictures (a) and (b) showing the surface states of a cooking plate subject to a coating process according to an embodiment of the disclosure before and after a chemical resistance test is applied to the cooking plate.

FIG. 11 is a table showing changes in color of the surface states in the chemical resistance test of FIG. 10.

FIG. 12 includes pictures (a) and (b) showing the surface states of a cooking plate subject to a coating process according to an embodiment of the disclosure before and after an easy cleaning test with respect to kimchi is applied to the cooking plate.

FIG. 13 includes pictures (a) through (d) showing the surface states of a cooking plate subject to a coating process according to an embodiment of the disclosure before and after a contamination resistance test with respect to kimchi is applied to the cooking plate.

FIG. 14 includes pictures (a) through (d) showing the surface states of a cooking plate subject to a coating process according to an embodiment of the disclosure before and after a contamination resistance test and an easy cleaning test with respect to soybean oil are applied to the cooking plate.

FIG. 15 includes pictures (a) through (d) showing the surface states of a cooking plate subject to a coating process according to an embodiment of the disclosure before and after a contamination resistance test and an easy cleaning test with respect to tomato sauce are applied to the cooking plate.

FIG. 16 includes pictures (a) through (d) showing the surface states of a cooking plate subject to a coating process according to an embodiment of the disclosure before and after a contamination resistance test and an easy cleaning test with respect to sugar are applied to the cooking plate.

### DETAILED DESCRIPTION

Configurations illustrated in the embodiments and the drawings described in the specification are example embodiments of the disclosure, and thus it is to be understood that various modified examples, which may replace the embodiments and the drawings described in the specification, are possible.

Also, like reference numerals or symbols denoted in the drawings of the specification represent members or components that perform substantially the same functions.

The terms used in the specification are used to describe the embodiments, and are not intended to limit and/or restrict the disclosure. It is to be understood that the singular forms “a,” “an,” and “the” include plural referents unless the context clearly dictates otherwise. It will be understood that the terms “includes,” “comprises,” “including,” and/or “comprising,” when used in the specification, specify the presence of stated features, figures, steps, operations, components, members, or combinations thereof, but do not preclude the presence or addition of one or more other features, figures, steps, operations, components, members, or combinations thereof.

Also, it will be understood that, although the terms including ordinal numbers, such as “first”, “second”, etc., used in the specification may be used to describe various components, these components should not be limited by these terms. These terms are used to distinguish one component from another. For example, a first component could be termed a second component, and, similarly, a second component could be termed a first component, without departing from the scope of the disclosure.

When it is stated in the disclosure that one element is “connected to” or “coupled to” another element, the expression encompasses an example of a direct connection or direct coupling, as well as a connection or coupling with another element interposed therebetween.

Meanwhile, in the following description, the terms “front”, “rear”, “left”, and “right” are defined based on the drawings, and the shapes and positions of the components are not limited by the terms.

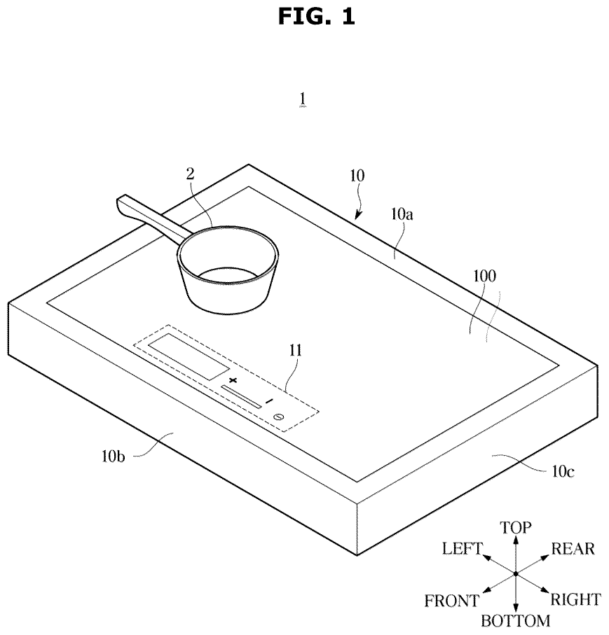

More specifically, as shown in FIG. 1, a direction in which a front surface 10b is shown is defined as a front direction, and rear, left, right, top, and bottom directions are defined based on the front direction.

The scope of the expression or phrase of “and/or” includes a plurality of combinations of relevant items or any one item among a plurality of relevant items. For example, the scope of the expression or phrase “A and/or B” includes the item “A”, the item “B”, and the combination of items “A and B”.

In addition, the scope of the expression or phrase “at least one of A and B” is intended to include all of the following: (1) at least one of A, (2) at least one of B, and (3) at least one A and at least one of B. Likewise, the scope of the expression or phrase “at least one of A, B, and C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

An aspect of the disclosure is directed to providing a cooking plate with improved heat tolerance, chemical resistance, easy cleaning, and scratch resistance, a manufacturing method thereof, and a cooking apparatus including the cooking plate.

Another aspect of the disclosure is directed to providing a cooking plate capable of minimizing delamination between a plurality of layers, a manufacturing method thereof, and a cooking apparatus including the cooking plate.

According to examples of the disclosure, contaminants attached on a cooking apparatus may be easily removed.

According to examples of the disclosure, a cooking plate with minimized delamination between a plurality of layers may be provided.

Hereinafter, embodiments of the disclosure will be described in detail with reference to the accompanying drawings.

FIG. 1 is a perspective view of a cooking apparatus according to an embodiment of the disclosure.

Referring to FIG. 1, a cooking apparatus 1 may include a main body 10 which forms an outer appearance of the cooking apparatus 1 and in which various members constituting the cooking apparatus 1 are installed. On a top surface 10a of the main body 10, a cooking plate 100 being in the shape of a flat plate, on which a cooking container 2 is placed, may be provided. The cooking plate 100 may include tempered glass such as ceramic glass to be prevented from being easily broken. However, a material of the cooking plate 100 is not limited to tempered glass.

On one side of the cooking plate 100, a user interface 11 for receiving a control command from a user and displaying operation information of the cooking apparatus 1 for the user may be provided. However, a location of the user interface 11 is not limited to an upper side of the cooking plate 100, and the user interface 11 may be provided at various locations, such as the front surface 10b of the main body 10 and/or a side surface 10c of the main body 10.

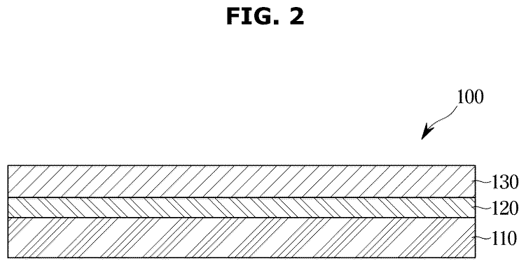

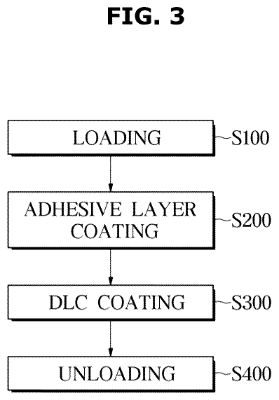

FIG. 2 shows laminating of a cooking plate in the cooking apparatus shown in FIG. 1. FIG. 3 is a flowchart showing a method of manufacturing the cooking plate shown in FIG. 2.

Referring to FIGS. 2 and 3, the cooking plate 100 according to an embodiment of the disclosure may include a base material 110, a diamond-like carbon (DLC) coating layer 130 formed on the base material 110, and an adhesive layer 120 interposed between the DLC coating layer 130 and the base material 110. The DLC coating layer 130 may form an outermost surface, and contact the cooking container 2. The adhesive layer 120 may also be referred to as a buffer layer 120.

The adhesive layer 120 may have a thickness of 0.1 μm to 0.9 μm, and the DLC coating layer 130 may have a thickness of 1 μm to 3 μm. For example, the adhesive layer 120 may have a thickness of 0.1 μm to 0.5 μm, and the DLC coating layer 130 may have a thickness of 1 μm to 1.5 μm. However, the thicknesses of the adhesive layer 120 and the DLC coating layer 130 are not limited to the above-mentioned examples.

The cooking plate 100 may be coated by loading the base material 110 (S100), coating the adhesive layer 120 on an upper surface of the cooking plate 100 (S200), DLC coating an upper surface of the adhesive layer 120 to form the DLC coating layer 130 (S300), and then unloading the base material 110 (S400).

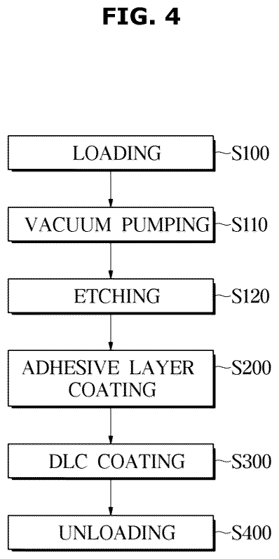

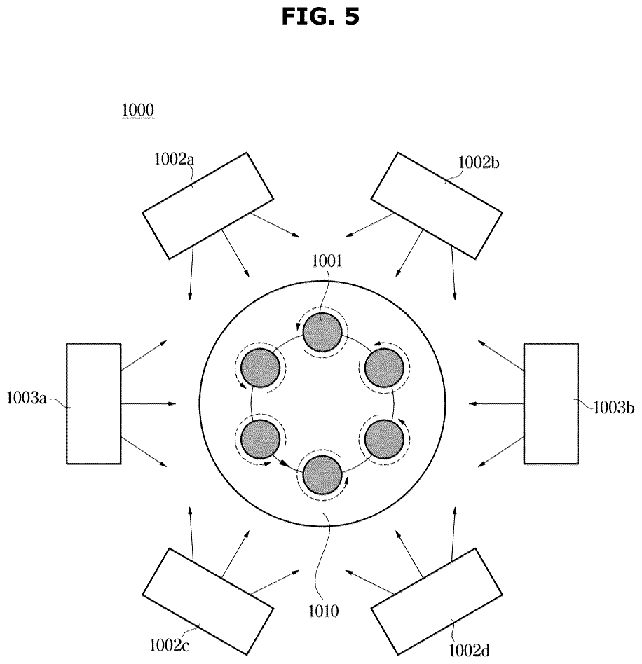

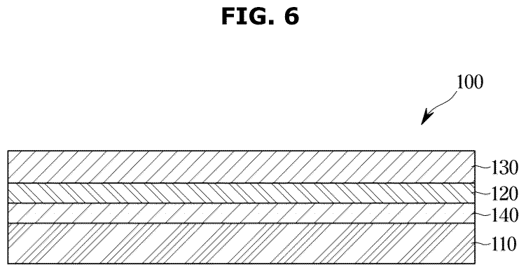

FIG. 4 is a flowchart showing additional features of the method of manufacturing the cooking plate, shown in FIG. 3. FIG. 5 schematically shows a process for forming the cooking plate shown in FIG. 2. FIG. 6 shows laminating of a cooking plate in a cooking apparatus according to an embodiment of the disclosure.

Referring to FIGS. 4 to 6, adhesive layer coating and DLC coating in a coating process of the application may be performed as follows.

A coating system for performing a coating process may include ion guns 1002a, 1002b, 1002c, and 1002d and evaporators 1003a and 1003b inside a chamber 1000. The ion guns 1002a, 1002b, 1002c, and 1002d may be provided as four pieces and arranged to form a quadrangular shape. The evaporator 1003a may be positioned between the ion gun 1002a and the ion gun 1002c. Also, the evaporator 1003b may be positioned between the ion gun 1002b and the ion gun 1002d. The coating system for performing a coating process according to the disclosure may include two evaporators 1003a and 1003b. In a center portion of the coating system, a base material 1001 may be positioned on a substrate 1010, and the base material 1001 may rotate to perform coating.

The base material 1001 may be loaded on the substrate 1010 (S100).

Thereafter, pumping may be performed (S110). According to an embodiment of the disclosure, vacuum pumping may be performed for about 180 minutes, and the internal air pressure of the chamber 1000 may be maintained at 5.0*10⁻⁵ torr or lower. That is, the inside of the chamber 1000 may be pumped to form a vacuum environment.

A surface of the base material 1001 may be etched. The etching may be aimed to arrange and activate the surface of the base material 1001 before a coating layer is formed. According to an embodiment of the disclosure, an etching portion 140 may be formed between the base material 1001 or 110 and the buffer layer 120 (see FIG. 6). The etching portion 140 may be formed in a Linear Ion Source (LIS) operation which will be described later. That is, the ion guns may perform spraying onto the surface of the base material 1001 or 110 to form the etching portion 140.

The LIS operation, which is a kind of a Physical Vapor Deposition (PVD) method, of spraying an ion beam may be performed on the base material 1001. The LIS may be performed for about 120 minutes. The LIS may be performed by injecting argon (Ar) by 10 standard cubic centimeters per minute (sccm) (cm³/min) to 50 sccm or cm³/min into the chamber, and applying a voltage of 1300±500 V to the substrate 1010. Through the LIS operation, an adhesive force of the coating layer with respect to the base material 1001 may be improved. Also, both the buffer layer and the DLC coating layer may be formed by the LIS operation.

For example, a voltage of 1300±500 V may be applied to the ion guns 1002a, 1002b, 1002c, and 1002d, and the ion guns 1002a, 1002b, 1002c, and 1002d may perform spraying onto the substrate 1010.

Buffer coating may be performed on the base material 1001 (S200). The buffer coating S200 may be Si or SiO coating. As an example, the buffer coating S200 may include a Trimethoxysilane (TMS) coating. The buffer coating may also be performed through a LIS operation. The buffer coating may be performed for about 360 minutes by injecting argon (Ar) by 50 sccm to 100 sccm and applying power of 300 W to 2900 W in the range of a voltage of 500 V to 2900 V and current of 0.1 A to 1 A to the substrate 1010.

The buffer coating may be aimed to improve an adhesive force between the base material 1001 or 110 and the DLC coating layer 130. The buffer coating may be performed through vacuum deposition of heating and vaporizing Trimethoxysilane (TMS) to deposit a metal as a thin film with vapor. That is, the buffer layer 120 formed with at least one of TMS, Si, and SiOₓ may be coated on the etching portion 140 by using the evaporators 1003a and 1003b. That is, the buffer layer 120 may be formed with TMS, Si, SiOₓ, TMS and Si, TMS and SiOₓ, Si and SiOₓ, or TMS, Si, and SiOₓ.

When the buffer layer 120 includes Si, delamination between the ceramic glass 110 and the DLC coating layer 130 may be prevented, resulting in an increase of an adhesive force.

DLC coating may be performed on the buffer layer 120 (S300). The DLC coating according to an embodiment of the disclosure may use ion deposition. The ion deposition may be a method of ionizing a hydrocarbon gas by plasma discharge and causing acceleration and collision with the substrate 1010 to form a film. More specifically, by performing spraying on the base material 1001 or 110 through the ion guns 1002a, 1002b, 1002c, and 1002d, the DCL coating layer 130 may be coated on the buffer layer 120. As the hydrocarbon gas, acetylene (C₂H₂), methane (CH₄), and benzene (C₆H₆) may be used. The DLC coating according to an embodiment of the disclosure may be performed for about 420 minutes by injecting acetylene (C₂H₂) by 10 sccm to 50 sccm and applying power of 1100 V to 2500 V to the substrate 1010. Bias power may be 100 V to 250 V. The DLC coating may be performed by adjusting power that is applied to the ion guns 1002a, 1002b, 1002c, and 1002d and the substrate 1010.

That is, the etching portion 140, the buffer layer 120, and the DLC coating layer 130 may be formed by the LIS process.

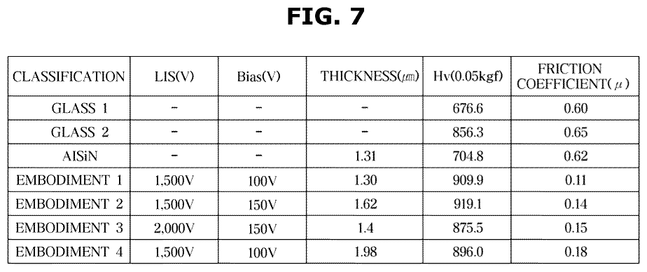

FIG. 7 is a table showing changes of surface hardness and a friction coefficient of a cooking plate according to an embodiment of the disclosure.

More specifically, in FIG. 7, GLASS 1 and GLASS 2 are cases in which no coating is applied, and FIG. 7 is a table showing comparisons between cooking plates to which AlSiN coating and a coating process according to an embodiment of the disclosure are applied, wherein the thickness (μm) represents a thickness of the entire coating layer, Hv represents Vickers hardness, and a friction coefficient (μm) may be a friction coefficient measurement value using a Tribometer.

Embodiment 1 of the disclosure is a case in which a LIS voltage of 1500 V is applied, a Bias voltage is set to 100 V, and a thickness of the entire coating layer is set to 1.30 μm. According to Embodiment 1, it is seen that Vickers hardness increases by 50 kg/mm 2 to 200 kg/mm² and a friction coefficient also decreases by about 0.5, compared with ceramic glass without coating and AlSiN coating.

Embodiment 2 is a case in which a LIS voltage of 1500 V is applied, a Bias voltage is set to 150 V, and a thickness of the entire coating layer is set to 1.62 μm. According to Embodiment 2, it is seen that Vickers hardness increases by 60 kg/mm 2 to 210 kg/mm² and a friction coefficient also decreases by about 0.5, compared with ceramic glass without coating and AlSiN coating.

Embodiment 3 is a case in which a LIS voltage of 2000 V is applied, a Bias voltage is set to 150 V, and a thickness of the entire coating layer is set to 1.4 μm. According to Embodiment 3, it is seen that Vickers hardness increases by 20 kg/mm 2 to 170 kg/mm² and a friction coefficient also decreases by about 0.5, compared with ceramic glass without coating and AlSiN coating.

Embodiment 4 is a case in which a LIS voltage of 1500 V is applied, a Bias voltage is set to 100 V, and a thickness of the entire coating layer is set to 1.98 μm. According to Embodiment 4, it is seen that Vickers hardness increases by 40 kg/mm 2 to 190 kg/mm² and a friction coefficient also decreases by about 0.5, compared with ceramic glass without coating and AlSiN coating.

Referring to FIG. 7, it is seen that the case in which the coating process according to the embodiment of the disclosure is performed increases Vickers hardness to a great value, compared with the case in which no coating is applied and the case in which AISiN coating is applied. Also, a friction coefficient value is significantly lowered, and accordingly, a smooth surface of the cooking plate 100 may be implemented.

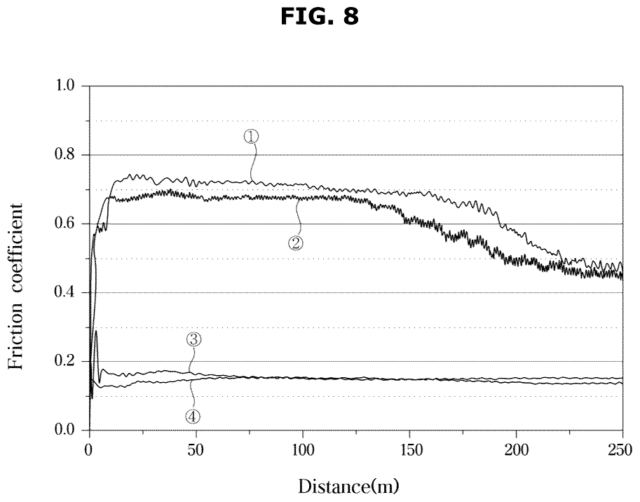

FIG. 8 is a graph showing changes of a friction coefficient of a cooking plate according to an embodiment of the disclosure.

Referring to FIG. 8, \textcircled{1} and \textcircled{2} are examples of cooking plates to which typical coating methods are applied, and \textcircled{3} and \textcircled{4} are graphs representing friction coefficient measurement values of the cooking plate 100 to which a coating process according to an embodiment of the disclosure is applied, according to a test distance.

According to an embodiment of the disclosure, constant small friction coefficients may be maintained in a test distance of 0 m to 250 m. Accordingly, a smooth surface of the cooking plate 100 may be implemented.

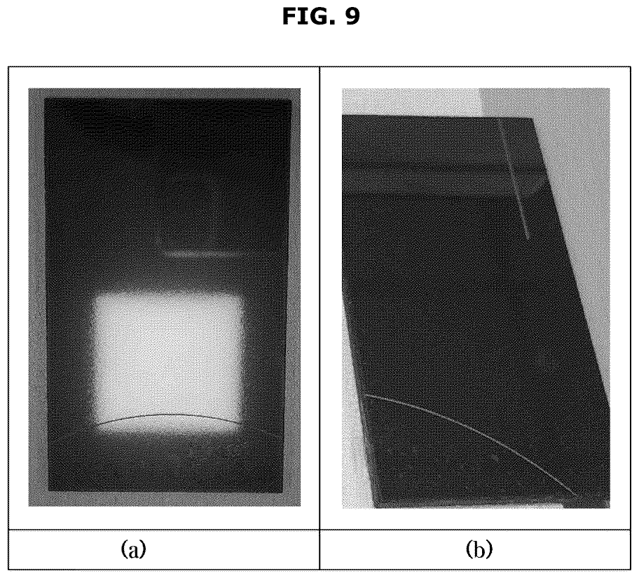

FIG. 9 includes pictures (a) and (b) showing the surface states of a cooking plate subject to a coating process according to an embodiment of the disclosure before and after a hot water resistance test is applied to the cooking plate.

In FIG. 9, picture (a) is taken before the hot water resistance test, and picture (b) is taken when 24 hours elapse after the cooking plate 100 is deposited by ½ in water of 95° C. It is seen from the pictures that the surface of the cooking plate has no change even after being left in water for 24 hours or more.

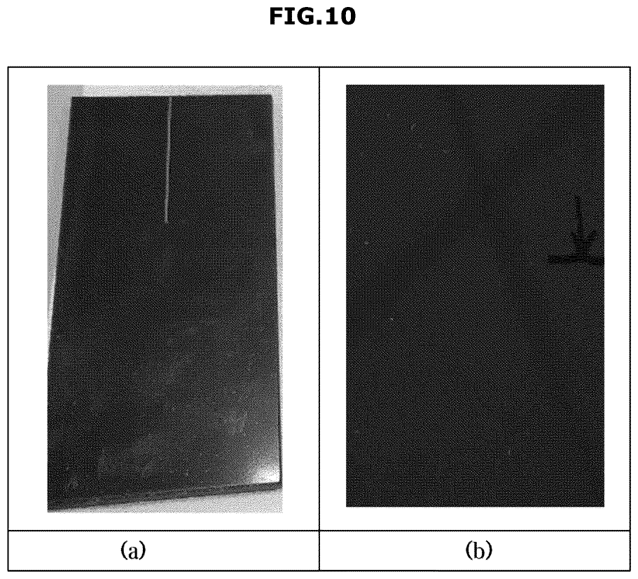

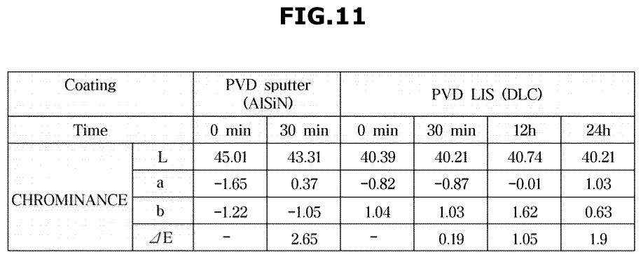

FIG. 10 includes pictures (a) and (b) showing the surface states of a cooking plate subject to a coating process according to an embodiment of the disclosure before and after a chemical resistance test is applied to the cooking plate. FIG. 11 is a table showing changes in color of the surface states in the chemical resistance test of FIG. 10.

In FIG. 10, picture (a) is taken before the chemical resistance test, and picture (b) is taken when 24 hours elapse after the cooking plate 100 is deposited by ½ in a sodium hydroxide solution of 5%. It is seen from the pictures that the surface of the cooking plate has no change even after being left in an alkaline solution for 24 hours or more.

Referring to FIG. 11, color changes according to AISiN coating through a PVD sputter method and DLC coating through a PVD LIS method being a coating process of the disclosure may be represented by numerical values. L may be a value representing brightness; the value “a” may be closer to red as its plus (+) value is greater and closer to green as its minus (−) value is greater; the value “b” may be closer to yellow as its plus (+) value is greater and closer to blue as its minus (−) value is greater.

Chrominance may be represented by ΔE. Chrominance ΔE=[(ΔL)²+(Δa)²+(Δb)²]^{1/2}. ΔL=Lₜ−L, Δa=aₜ−a, and Δb=bₜ−b, wherein t represents a value after time t.

In the case of AlSiN coating, a ΔE value was 2.65 when 30 minutes have elapsed in a sodium hydroxide solution of 5%. According to an embodiment of the disclosure, a ΔE value was measured as 0.19 when 30 minutes have elapsed in a sodium hydroxide solution of 5%, a ΔE value was measured as 1.05 when 12 hours have elapsed, and a ΔE value was measured as 1.9 when 24 hours have elapsed.

Accordingly, it is seen that the cooking plate 100 according to an embodiment of the disclosure showed little discoloration due to a significant increase of chemical resistance.

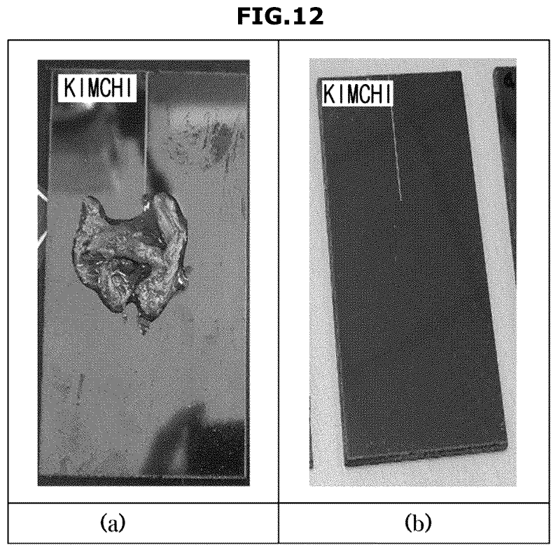

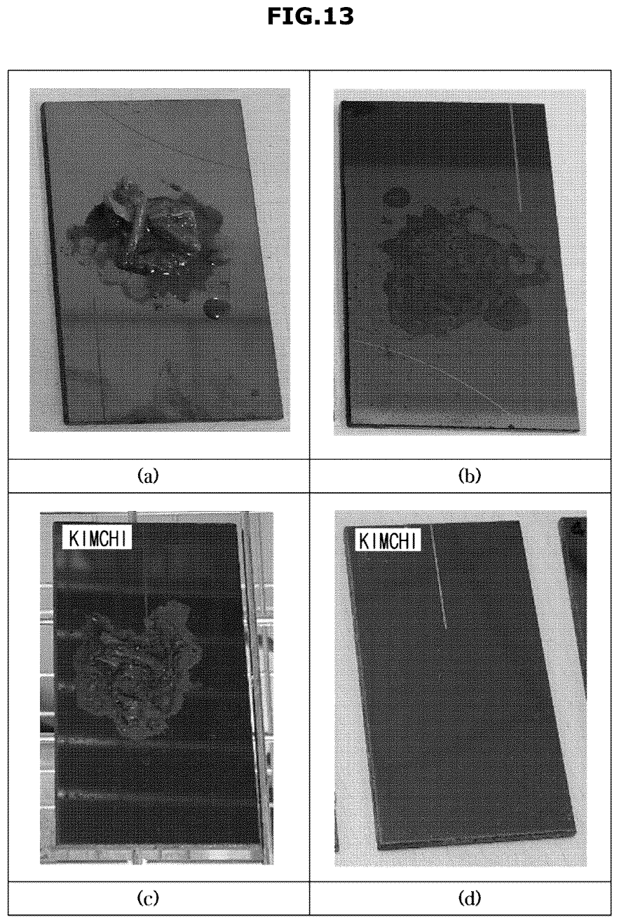

FIG. 12 includes pictures (a) and (b) showing the surface states of a cooking plate subject to a coating process according to an embodiment of the disclosure before and after an easy cleaning test with respect to kimchi is applied to the cooking plate. FIG. 13 includes pictures (a) through (d) showing the surface states of a cooking plate subject to a coating process according to an embodiment of the disclosure before and after a contamination resistance test with respect to kimchi is applied to the cooking plate.

In FIG. 12, picture (a) is taken immediately after kimchi is placed on the cooking plate, and picture (b) is taken when the kimchi was cleaned after 24 hours have elapsed at a temperature of 70° C. It is seen from the pictures that the surface of the cooking plate has no change even when kimchi is left on the surface of the cooking plate for 24 hours or more.

In FIG. 13, picture (a) is taken immediately after kimchi is placed on the cooking plate, and picture (b) is taken after 30 minutes have elapsed at a temperature of 300° C. In FIG. 13, picture (c) is taken after 60 minutes have elapsed at temperature of 300° C., and picture (d) is taken after kimchi stains were cleaned. According to an embodiment of the disclosure, it is seen that the cooking plate was not contaminated although kimchi was left on the cooking plate at high temperature, as shown in picture (d) of FIG. 13.

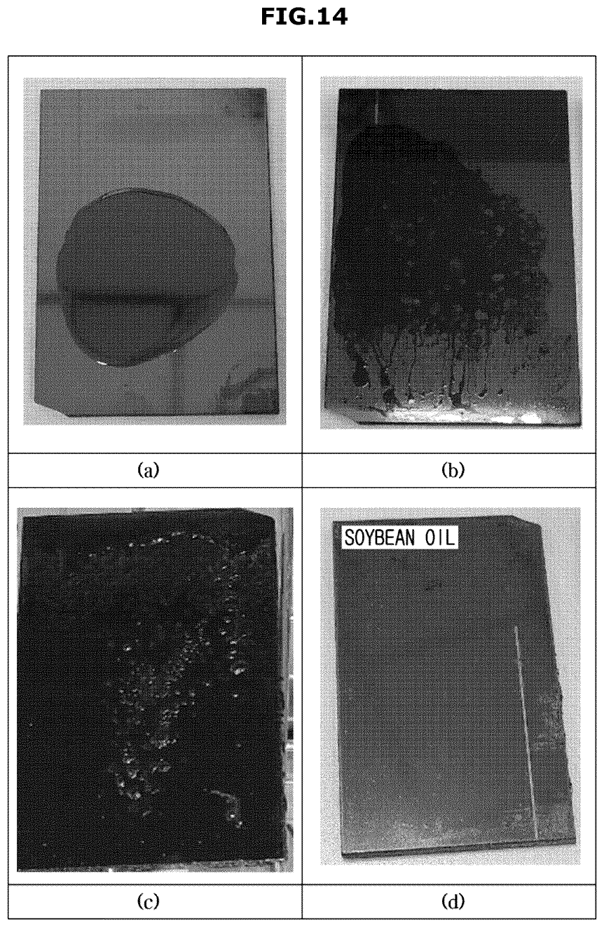

FIG. 14 includes pictures (a) through (d) showing the surface states of a cooking plate subject to a coating process according to an embodiment of the disclosure before and after a contamination resistance test and an easy cleaning test with respect to soybean oil are applied to the cooking plate.

In FIG. 14, picture (a) is taken immediately after soybean oil is placed on the cooking plate, and picture (b) is taken after 30 minutes have elapsed at a temperature of 300° C. In FIG. 14, picture (c) is taken after 60 minutes have elapsed at temperature of 300° C., and picture (d) is taken after the soybean oil was cleaned. According to an embodiment of the disclosure, it is seen that soybean oil was completely cleaned without any stain remaining on the cooking plate although the soybean oil was left on the cooking plate at high temperature, as shown in picture (d) of FIG. 14. That is, it is seen that the cooking plate was not contaminated.

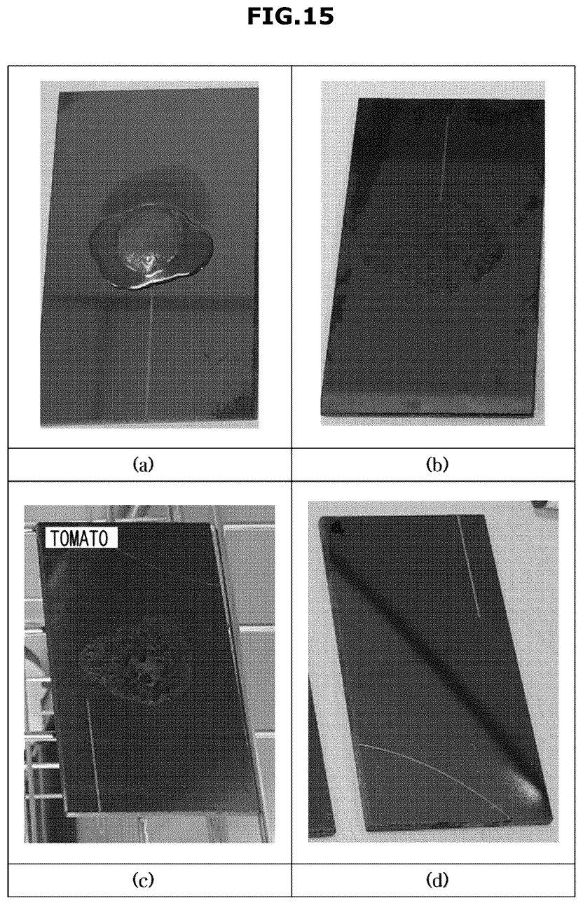

FIG. 15 includes pictures (a) through (d) showing the surface states of a cooking plate subject to a coating process according to an embodiment of the disclosure before and after a contamination resistance test and an easy cleaning test with respect to tomato sauce are applied to the cooking plate.

In FIG. 15, picture (a) is taken immediately after tomato sauce is placed on the cooking plate, and picture (b) is taken after 30 minutes have elapsed at a temperature of 300° C. In FIG. 15, picture (c) is taken after 60 minutes have elapsed at temperature of 300° C., and picture (d) is taken after the tomato sauce was cleaned. According to an embodiment of the disclosure, it is seen that tomato sauce was completely cleaned without any stain remaining on the cooking plate although the tomato sauce was left on the cooking plate at high temperature, as shown in picture (d) of FIG. 15. That is, it is seen that the cooking plate was not contaminated.

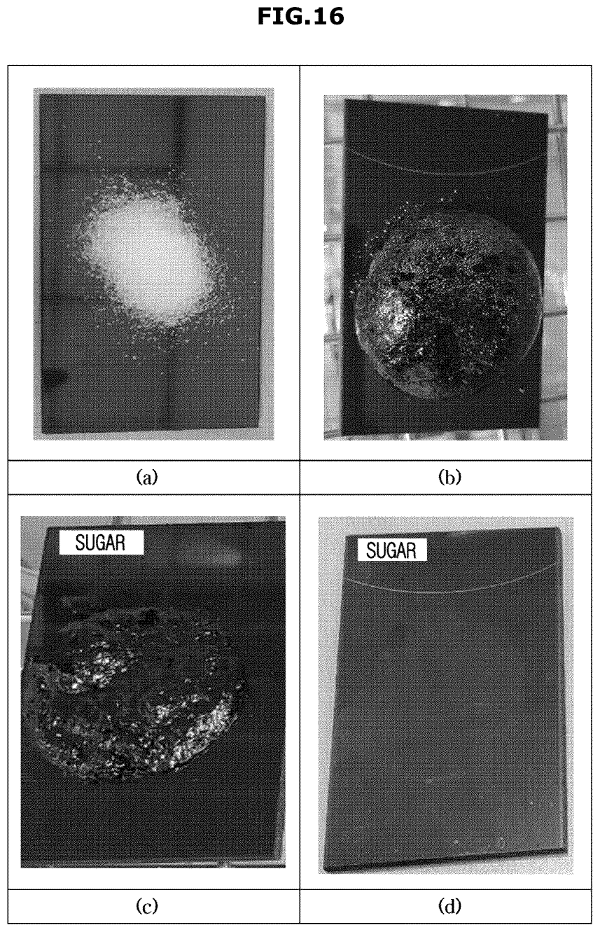

FIG. 16 includes pictures (a) through (d) showing the surface states of a cooking plate subject to a coating process according to an embodiment of the disclosure before and after a contamination resistance test and an easy cleaning test with respect to sugar are applied to the cooking plate.

In FIG. 16 picture (a) is taken immediately after sugar is placed on the cooking plate, and picture (b) is taken after 30 minutes have elapsed at temperature of 300° C. In FIG. 16, picture (c) is taken after 60 minutes have elapsed at a temperature of 300° C., and picture (d) is taken after the sugar was cleaned. According to an embodiment of the disclosure, it is seen that sugar was completely cleaned without any stain remaining on the cooking plate although the sugar was left on the cooking plate at high temperature, as shown in picture (d) of FIG. 16. That is, it is seen that the cooking plate was not contaminated.

Example embodiments have been shown and described, however, the disclosure is not limited to these embodiments. It should be understood that various modifications may be made by one of ordinary skill in the technical art to which the disclosure belongs, without departing from the spirit and scope of the disclosure, which is defined by the following claims and their equivalents.

What is claimed is:

1. A cooking apparatus, comprising:
a main body; and
a cooking plate mounted on an upper surface of the main body to cook a cooking material, the cooking plate including:
a base material,
a diamond-like carbon (DLC) coating layer, formed on an upper surface of the base material as an outermost layer of the cooking plate and on which a cooking container is placeable, and
an adhesive layer interposed between the base material and the DLC coating layer, and including at least one of Si and SiOₓ.

2. The cooking apparatus of claim 1, wherein the adhesive layer includes trimethoxysilane to improve an adhesive force between the base material and the DLC coating layer.

3. The cooking apparatus of claim 1, wherein the base material includes ceramic glass.

4. The cooking apparatus of claim 1, wherein at least one of the DLC coating layer and the adhesive layer is formed by a physical vapor deposition (PVD) method.

5. The cooking apparatus of claim 4, wherein the PVD method includes a linear ion source method of spraying an ion beam.

6. The cooking apparatus of claim 1, wherein a thickness of the adhesive layer is 0.1 μm to 0.9 μm.

7. The cooking apparatus of claim 1, wherein a thickness of the DLC coating layer is 1 μm to 3 μm.

8. A method of manufacturing a cooking plate, comprising:
preparing a base material including ceramic glass;
coating a buffer layer including at least one of Si and SiOₓ on the base material; and
coating a diamond-like carbon (DLC) coating layer on the buffer layer, wherein the buffer layer is interposed between the DLC coating layer and the ceramic glass.

9. The method of claim 8, wherein the buffer layer includes trimethoxysilane to improve an adhesive force between the base material and the DLC coating layer.

10. The method of claim 9, further comprising etching a surface of the base material through linear ion source processing before coating the DLC coating layer.

11. The method of claim 8, further comprising performing a physical vapor deposition (PVD) method to coat at least one of the buffer layer and the DLC coating layer.

12. The method of claim 11, wherein
the PVD method includes a linear ion source (LIS) method, and
a supply voltage of the LIS method is 500 V to 2900 V.

13. The method of claim 12, wherein
a supply power of the LIS method is 300 W to 2900 W.

14. The method of claim 8, wherein
a thickness of the buffer layer is 0.1 μm to 1.0 μm, and
a thickness of the DLC coating layer is 0.5 μm to 2.0 μm.

15. The method of claim 8, wherein the DLC coating layer is an outermost surface of the cooking plate on which a cooking container is to be placed.

16. A cooking plate, comprising:
a base material including ceramic glass;
a diamond-like carbon (DLC) coating layer formed on an upper surface of the base material; and
an adhesive layer interposed between the base material and the DLC coating layer, wherein the adhesive layer includes at least one of Si and SiOₓ.

17. The cooking plate of claim 16, wherein the adhesive layer includes trimethoxysilane to improve an adhesive force between the base material and the DLC coating layer.

18. The cooking plate of claim 16, wherein at least one of the DLC coating layer and the adhesive layer is formed by a physical vapor deposition (PVD) method.

19. The cooking plate of claim 18, wherein the PVD method includes a linear ion source method.

20. The cooking plate of claim 16, wherein
a thickness of the adhesive layer is 0.1 μm to 1.0 μm, and
a thickness of the DLC coating layer is 0.5 μm to 2.0 μm.
